(19) United States
(12) Patent Application Publication
(10) Pub. No.: US 2008/0057877 A1
(43) Pub. Date: Mar. 6, 2008

(54) SYSTEM AND METHOD TO RAPIDLY DEPLOY ONE OR MORE COMMUNICATION DEVICES

(75) Inventor: Ellis A. Pinder, Davie, FL (US)

Correspondence Address: MOTOROLA, INC, 1303 EAST ALGONQUIN ROAD, IL01/3RD, SCHAUMBURG, IL, 60196, US

(73) Assignee: MOTOROLA, INC., Plantation, FL (US)

(21) Appl. No.: 11/469,280

(22) Filed: Aug. 31, 2006

(51) Int. Cl. H04B 1/40

(52) U.S. Cl. 455/75

(57) ABSTRACT

A Rapid Deployment Pack (110) contains at least one communication device such as radio (112) that includes personal area network (PAN) module (200). PAN module (200) can operate independently from radio (112), including when radio (112) is powered off, and can receive an update file containing radio configuration information. Programming station (160) discovers radio (112) and is able to send the update file. PAN module (200) is able to receive and store the update file until radio (112) powers on. Upon power-up of radio (112), the radio will detect the update file in PAN module (200) and use the information to update its configuration information. Preferably, the update operation is performed on a plurality of radios within Rapid Deployment Pack (110) while the pack is sealed.

### RELATED APPLICATIONS

This application is cross-related to applications, attorney docket numbers CM10517J, CM10518J, and CM10519J, which are owned by the assignee of the present invention.

### TECHNICAL FIELD

This invention relates in general to two-way communications systems and more particularly to the configuration of a two-way communication device for rapid deployment of a communication system.

### BACKGROUND

Natural and man-made disasters generally occur without warning and require a coordinated response. Good communication is paramount to a coordinated disaster response; however, the disaster itself may impair or destroy some or the entire communication infrastructure in the affected area. For example, Hurricane Katrina (2005) caused widespread destruction on the Gulf Coast of the United States and destroyed a significant portion of the region's communication infrastructure. Alternately, the disaster may occur in a remote area where no such infrastructure previously existed.

Emergency communication equipment currently available to deal with such circumstances includes portable repeaters, mobile “suitcase” base stations, and mobile trunking sites on trailers. A number of issues arise when using such emergency communication infrastructure, including: existing radios may require reconfiguration to use the emergency infrastructure; additional radios are often needed which must be configured to use the emergency infrastructure; and additional help called into disaster areas requires reconfiguration of the additional radios, or the issuance of new radios to use the emergency infrastructure.

The reconfiguration of existing radios can be time-consuming and inconvenient. Over-the-air programming via fixed infrastructure may be an appropriate approach in some cases, however the over-the-air approach will not work if infrastructure is damaged or destroyed or for radios normally associated with another system. In many instances, the reconfiguration of existing radios can be avoided by good planning. For example, a county communication manager could ensure that “first responder” (i.e. police, fire, ambulance) radios are configured for both normal, non-disaster communications and for special event communications such as disaster response. The county could purchase or have a sharing agreement in place to deploy emergency communication equipment with a known configuration. Because the configuration of the undeployed equipment is known a priori, first responder radios can be configured in advance to work with such equipment. Local governments with limited budgets, however, may not own or have a sharing agreement in place.

More challenging, however, is the need to program additional, perhaps new, radios during a disaster situation. It is very common for additional communication devices to be needed immediately in response to a disaster, which, of course, is the least desirable time to configure such radios for use. Such radios cannot necessarily be pre-configured, because their deployment location may not yet be known. Even if the additional communication devices travel together with emergency infrastructure, additional configuration may be very desirable to allow the radios to operate on additional channels or systems that may be available in the target area. Programming often requires cables, a laptop, and programming software, perhaps for each radio, and programming equipment may not be readily available when needed. Programming can often be time-consuming, especially when a large number of radios are involved.

Emergency operations planners and similar individuals need a means to rapidly move a quantity of radios to a given location and have them ready for use as quickly as possible using a minimum amount of equipment and process steps. In some instances it is also desirable to be able to configure the radios prior to delivery so that the radios work immediately upon arrival.

Accordingly, there is a need for a system and method to rapidly deploy radios.

### BRIEF DESCRIPTION OF THE DRAWINGS

The features of the present invention, which are believed to be novel, are set forth with particularity in the appended claims. The invention, together with further objects and advantages thereof, may best be understood by reference to the following description, taken in conjunction with the accompanying drawings, in the several FIGs. of which like reference numerals identify like elements, and in which:

FIG. 1 is a system diagram for use in the rapid deployment of radios in accordance with the present invention;

FIG. 2 is a block diagram of a two-way radio with PAN interface formed in accordance with the present invention;

FIG. 3 is a method for rapidly deploying radios in accordance with the present invention;

FIG. 4 is a method for a PAN module to download configuration information in accordance with the present invention;

FIG. 5 is a method for updating radio configuration information in accordance with the present invention; and

FIG. 6 is a block diagram of radio memory and PAN module memory used in the communication system in accordance with the present invention.

### DETAILED DESCRIPTION OF THE PREFERRED EMBODIMENT

While the specification concludes with claims defining the features of the invention that are regarded as novel, it is believed that the invention will be better understood from a consideration of the following description in conjunction with the drawing figures, in which like reference numerals are carried forward.

In accordance with the present invention, there is provided herein a system and method to rapidly deploy and configure communication devices in response to deployment events such as natural disasters and man-made disasters. Additionally, the system and method provided herein may be used in non-disaster deployment events where a large deployment of radios is needed. An example is a planned event such as the Olympics where a large communication capability is needed regionally for a short duration. The system of the present invention allows for the rapid programming of one or more communication devices, including simultaneous programming, without disturbing the readiness state or packaging of the radios. The method of the present invention provides a means to wirelessly update the configuration of one or more radios while the radios remain in long term packaging.

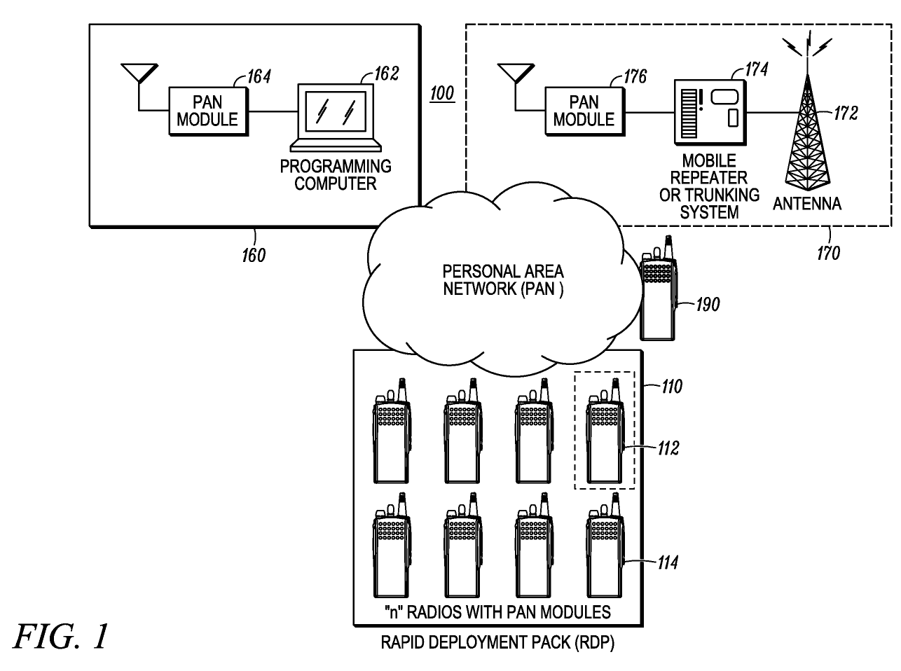

Referring to FIG. 1, there is shown a system diagram for use in the rapid deployment of radios in accordance with the present invention. System 100 includes a package, herein referred to as a “Rapid Deployment Pack,” or RDP 110, including at least one portable radio 112. System 100 may include a plurality of RDPs with each RDP having one or more radios contained therein. A programmer is used to program the radios of RDP 110 utilizing personal area network (PAN) technology. The programmer may be a computer equipped with a PAN module as shown in 160, or the programmer may be another PAN-equipped radio 190 existing in the field. PAN enabled programming station 160 is preferably a portable programming station including a portable computer 162 having a PAN module 164 coupled thereto or therein. In accordance with the present invention, the portable programming station 160 or PAN radio 190 is used to transmit configuration information via the PAN to the radios in each RDP 110. In another embodiment of the invention, an emergency mobile communication system 170 including an antenna 172, a mobile repeater or trunking system 174 and PAN module 176 are used to program radios 112 by taking the RDP 110 to the location of communication system 170 and programming the radios via a PAN link provided by PAN module 176.

In accordance with the present invention, system 100 provides for the deployment of radios via the “Rapid Deployment Pack,” or RDP 110. The RDP 110 preferably consists of a set of radios, such as radios 112 and 114 and may include additional components, such as batteries and antennas. The battery, if provided, may be a primary or secondary type, or the battery may be in the form of a battery pack that utilizes commercial cells such as “AA” type cells. Secondary cells are preferable for non-disaster situations, because the ability to recharge these types of cells makes them both convenient and economical. Primary cells such as an alkaline “AA” type battery pack may be preferable in certain disaster situations when responders cannot rely on the availability of chargers or even electrical power. The RDP 110 may optionally include carry accessories, remote microphones, instructions, and programming cable(s) if applicable.

In the preferred embodiment, rapid deployment pack 110 is a sealed unit of radios 112, 114 and accessories (not shown) that can be readily deployed as a stand-alone system. The sealed nature of pack 110 ensures that all equipment is present and all radios are in a known condition. RDP 110 can be stocked at a factory or distribution center of a radio manufacturer, it can be purchased by an end-user for future emergency use, and it can be purchased by a government agency that can make an RDP available as needed across a region. For example, the State of Florida may purchase fifty RDPs each containing ten radios. These radios may be used by state agencies for emergency response, or the state may loan RDPs to local governments who request them for local emergency response.

The sealed nature of the Rapid Deployment Pack 110 provides several advantages to facilitate the rapid deployment of radios. A new RDP 110 will be tested and supplied with requested options or accessories, and then sealed to ensure equipment has not been borrowed, stolen, modified, or re-configured in an undesirable manner. A sealed RDP 110 provides a set of radios and related accessories in a known state, ready for instant deployment. Configuration or programming of the radios by removal from the pack is tedious and use of traditional storage and packaging methods allows for misplaced equipment. The RDP 110 formed in accordance with the present invention provides a means to verify the contents of the RDP without opening the RDP or breaking its seal. After usage, the radios 112, 114, 190 can be re-packaged into the RDP 110 after testing, replacement of damaged items, replacement of expendable items (if applicable) such as primary cells, and reconfiguration of radios to a known state.

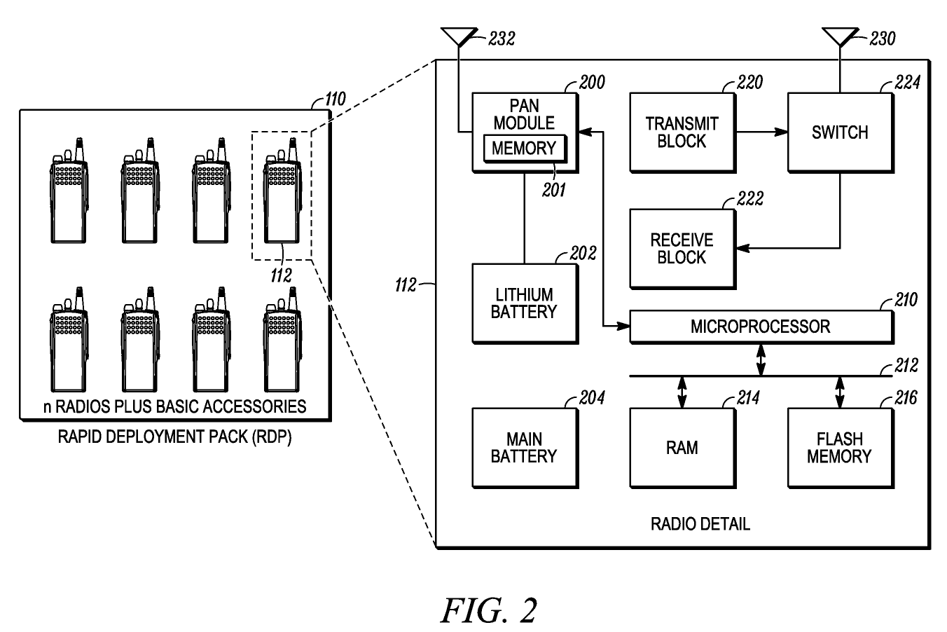

Referring now to FIG. 2, there is shown a preferred embodiment for radio 112 formed of a portable two-way radio with PAN interface. Radio 112 contains a radio transceiver for normal operation of the radio, which comprises transmit block 220, receiver block 222, and switch 224. Additionally, radio 112 contains, in accordance with the present invention, a PAN module 200, which preferably operates on a different frequency band from the radio's main transceiver (220, 222), has less range, and utilizes substantially less power. In accordance with the present invention, PAN module 200 is connected to radio processor 210, which controls the operation of the radio 112. Additionally, PAN module 200 preferably contains a non-volatile memory 201, such as flash memory. Non-volatile memory 201 may be used for PAN firmware as well as for file storage of downloaded files from the PAN link. Processor 210 accesses RAM 214 and Flash Memory 216 for normal operation of the radio. Processor 210 may contain multiple processor cores, and some or all of RAM 214, and Flash Memory 216 may be internal to processor 210.

The PAN module 200 allows low to moderate speed communication over a short distance to other similar PAN modules. The PAN module itself may utilize any PAN technology, including Zigbee/802.15.4 and Bluetooth to name a few. The use of PAN technology allows data link services, network services, discovery/association services, and security services to be incorporated within the RDP 110. In the preferred embodiment, the PAN module 200 is in the form of a removable option board in the radio 112, which eliminates the cost of PAN hardware for radios that do not require such capability, and allows for existing, non-PAN equipped radios to be upgraded. In an alternate embodiment, the PAN module may be a removable accessory in the form of a dongle which attaches to the side of the radio 112, perhaps through an existing electrical connector. For example, many two-way radios have an accessory connector for external microphones and/or programming. Such a connector can be utilized to attach a dongle containing a PAN module. A PAN dongle can thus be attached to each radio 112, 114 while in the RDP 110, and the dongle can be removed upon radio deployment. In another embodiment, the PAN module 200 may be permanently integrated into the radio 112 thus enabling the use of the PAN module for other features. In yet another embodiment, a single PAN module 200 in RDP 110 may be connected by a bus or wired network to all radios in the RDP.

Transmit block 220 and receive block 222 connect to antenna 230 through switch 224. These elements comprise the main transceiver portion of the radio for normal communication including voice and data communication to another radio or to infrastructure of appreciable distance. In contrast, PAN module 200 uses antenna 232 for communication over substantially shorter distances. While not shown, all or portions of the PAN module 200 can be combined with the primary transceiver. Antennas 230 and 232 may also be combined as well.

Radio 112 is powered by main battery 204 during normal operation. Main battery 204 is capable of operating the full radio including the operation of high-power transmitter 220. Battery 204 is also capable of powering PAN module 200. In the preferred embodiment, another battery, preferably a lithium battery 202, provides power to PAN module 200 when battery 204 is not connected to the radio or when battery 204 lacks sufficient charge. Lithium battery 202 may optionally be charged by battery 204. In the preferred embodiment, lithium battery 202 is incorporated as part of PAN module 200. In an alternate embodiment, lithium battery 202 can be attached to the radio.

PAN module 200 operates on substantially low-power and can be powered from batteries 202 and/or 204 for very long periods of time. Additionally, PAN module 200 is intended to operate even when the radio is powered off or in a substantially inactive state. In the preferred embodiment, PAN module 200 is a Zigbee-compliant module using the 802.15.4 standard. Zigbee-compliant devices are capable of operating for years on primary batteries. Additionally, lithium batteries provide the advantage of having an extremely long shelf-life making them highly desirable for use in RDP 110. The use of lithium batteries allows RDP 110 to remain in storage for an extended period of time beore being called to service.

The use of readily-available, disposable “AA” type alkaline batteries may also be desirable for disaster-type applications, as these types of batteries also have a long shelf life. If the radios of deployment pack 110 utilize alkaline batteries, the use of a lithium battery can be eliminated as the PAN module 200 can receive power from the main battery 204 even if the power switch of radio 112 is in the “off” position. In an alternate embodiment, the RDP 110 can have an independent power source for all PAN modules. Thus, many battery and power supply combinations that can be used to realize the RDP 110 of the present invention.

Returning back to FIG. 1, RDP 110 contains a set of PAN-equipped radios, such as radios 112 and 114. In accordance with the present invention, the PAN module 200 of each radio is powered while the radio is contained in RDP 110, even if the radio is “powered off.” Upon the occurrence of a deployment event, one or more RDPs are deployed. Upon arrival to the deployment site, the programming station 160 is used to transmit configuration information via the PAN to the set of radios 112, 114 in each RDP.

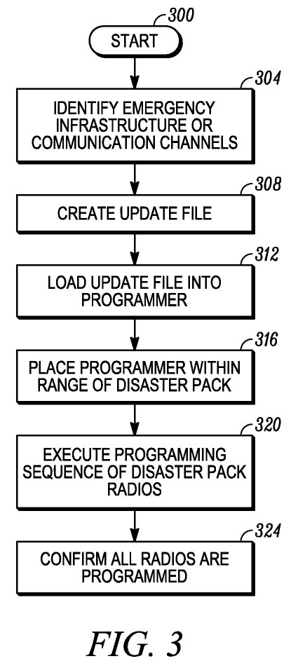

The method to rapidly deploy the radios is shown in FIG. 3. The method starts at 300, and at step 304 the configuration information needed to be placed in the target radios is identified. This configuration information preferably includes at least one of frequency information, squelch code information, trunking system information, channel assignment information, user ID and talkgroup ID information, and scan list information. This configuration may correspond to emergency communication infrastructure that has or will be deployed, to normal infrastructure, or to radio-to-radio “talk-around” frequencies. Those skilled in the art will recognize that this information is substantially similar to radio “codeplug” information. The radio codeplug normally defines the radio's operational capabilities.

Once the configuration information has been identified in step 304, an update file is created in step 308. The update file may be a complete radio codeplug that will be programmed, a partial radio codeplug, or it may be information stored in some parsable form that the radio will later interpret and use to replace, modify, or extend its codeplug. The update file formed in step 308 is loaded into a programming station, or “programmer”, in step 312. The programmer may be a computer equipped with a PAN module as shown in 160, or the programmer may be another PAN-equipped radio 190 as shown in FIG. 1. Programmer 160 or radio 190 is placed within PAN range of RDP 110 as specified in step 316.

In step 320, an operator executes the programming sequence via programmer 160 or radio 190 acting as a programmer. Within step 320, the programmer discovers all of the radios in RDP 110 over the Personal Area Network (PAN), transfers the update file to each radio, and then verifies that all radios received a complete and valid update file. Since the configuration information is the same for all of the radios, multicasting techniques may be used to improve efficiency.

In step 324, feedback is provided to the operator as to the result of the programming operation. This could be in the form of an audible alert or visual display. In the preferred embodiment, the number of radios discovered and the number successfully programmed would be provided to the user.

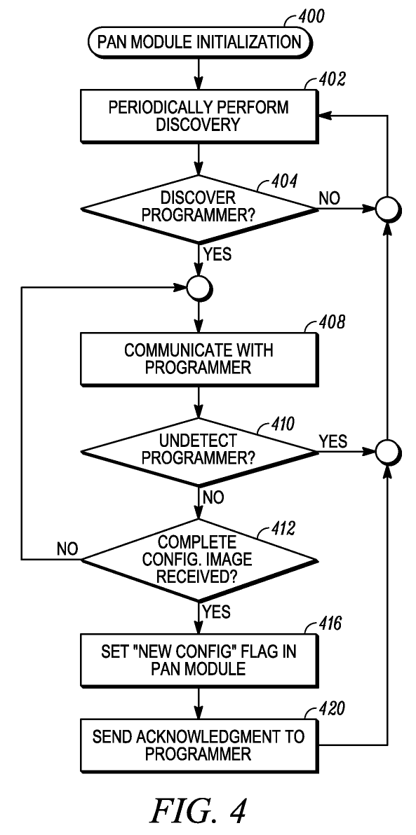

FIG. 4 shows additional method detail for step 320 from the perspective of the PAN module 200 in radio 112. Upon initial application of power to PAN module 200, the PAN module initializes itself in step 400. In step 402, the PAN module performs a discovery operation to detect the presence of a programmer, such as PAN enabled programmer 160 or PAN enabled radio 190 of FIG. 1. If no programmer is found in decision step 404, then discovery is attempted again in step 402. Step 402 specifies “periodically perform discovery” which means a delay element may be used to time the PAN module 200 as the module sleeps or places itself in an ultra-low power state. To achieve long battery life, the PAN module 200 sleeps for a large percentage of time as determined by the “shelf-life” that the RDP 110 is designed to achieve. Thus, the loop from 402 to 404 and back to 402 may take seconds or longer to complete.

If a programmer was discovered in step 404, the PAN module 200 wirelessly communicates with the programmer in step 408. Step 408 includes discovery response, identification, upload/download of data, error correction and retransmission, and validation or acknowledgements. If the communication with the programmer is lost, meaning the programmer is “undetected”, discovery is again attempted at step 402. If communication with the programmer is still available, a check is made to determine if the exchange of information is complete. If the PAN module has not yet received a complete and fully validated image, then operation continues at step 408. If all information has been received, then a “New Config” flag is set in the PAN module 200 in step 416. This flag indicates that a new configuration image is present that has not yet been uploaded to the radio. Upon setting the flag, an acknowledgement is sent to the programmer in step 420 indicating the configuration information download was successful to that PAN module.

In the preferred embodiment, downloading of the update file to the PAN module does not update the radio itself. The update file is stored in non-volatile memory 201 of PAN module 200 and the radio is not updated until the next time the radio is powered on. This allows radio 112 to remain substantially “off” while the PAN module functions independently.

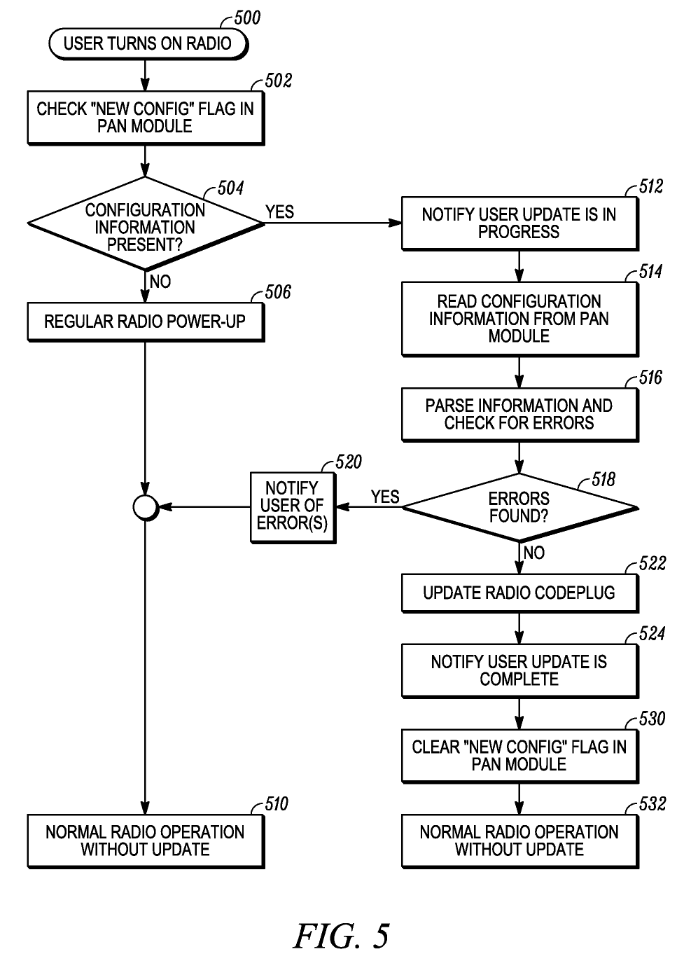

FIG. 5 illustrates the codeplug update process of radio 112 by PAN module 200. Note that this process is not shown in FIG. 3's flowchart, because RDP 100 may still be sealed. The codeplug update process typically occurs when the radio is first powered on after an update, and this process is executed by the firmware of radio 112. Returning to FIG. 5, when the user turns on radio 112 in step 500, the radio contains either a “not updated” codeplug or a special default codeplug. A “not updated” codeplug is simply the previous codeplug present which may be known or unknown. This could include a default codeplug with a known configuration that is placed into all radios. A “special default codeplug” is a codeplug specially configured to authorize exactly one update via the PAN module. Subsequent updates via the PAN module are disallowed by the radio, thereby preventing inadvertent or malicious reprogramming of the radio. A special default codeplug is installable by the radio manufacturer, and optionally the customer may install such a codeplug via a hardwired connection to the radio. Although use of the special default codeplug has security advantages, preparation and repackaging of an RDP for subsequent usage now requires additional effort, which is the manual programming of each radio in the RDP with a special default codeplug.

At step 502, which likely occurs during the power-up sequence of radio 112, the radio checks the “New Config” flag in the PAN module 200 to determine whether new configuration information is present from a previously downloaded update file. At decision step 504, a determination of the presence of new configuration information is made. If no new configuration information is present in PAN module 200, then the radio proceeds with regular power-up in step 506 and then continues on to normal operation 510 without any configuration information update. If no new configuration information is available, then the radio's processing of steps 502 and 504 would be preferably transparent to the user.

If new configuration information was detected in step 504, then an update sequence is started which begins by notifying the user 512 that an update is in process. Next, the radio reads the update file containing configuration information from PAN module 200 in step 514. The radio parses this information in step 516 to validate that the information is valid and compatible with radio 112. If an error is detected, that is the update file is invalid or not compatible in decision step 518, the user is notified in step 520 and the radio returns to normal operation 510 without any configuration update. In such a case, the configuration information will have to be downloaded again via PAN module 200. If no error was found in step 518, then the radio will update its codeplug accordingly in step 522. The update file may consist of a complete or partial codeplug, or it may contain parsable information on how to replace, modify, or extend an existing codeplug. In either case, the radio ultimately benefits from a new or updated codeplug in step 522, which provides the radio with a new or updated operational configuration. In step 524, the user is notified that the update was successful. In step 530, the radio clears the “New Config” flag in the PAN module so the update operation is skipped in successive radio power-up sequences, unless a new update file is downloaded to PAN module 200. Finally in step 532 the radio begins normal operation with the updated codeplug.

In the preferred embodiment, the configuration information is stored in memory 201 in PAN module 200 until the radio is turned on, at which time the radio codeplug information is updated as shown in FIG. 5. In an alternate embodiment, PAN module 200 has the ability to turn on radio 112 thus allowing direct communication between the programmer i.e. PAN-enabled portable computer 160 or PAN-enabled radio 190, and processor 210. In this embodiment, memory 201 of PAN module 200 is not needed to store configuration information because the programmer has access to processor 210 and indirectly to the actual radio codeplug in flash memory 216.

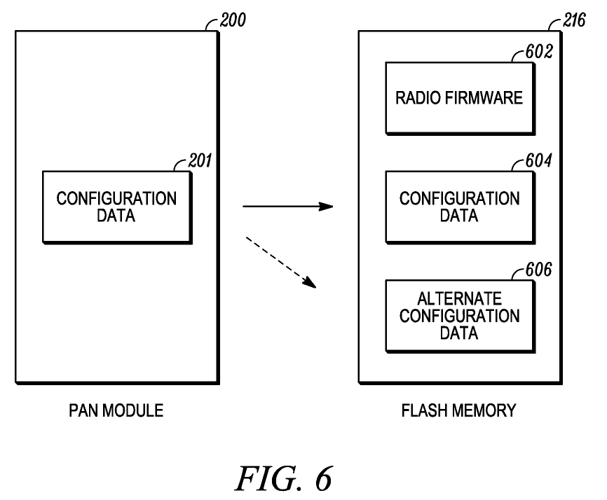

In yet another embodiment, configuration information downloaded by PAN module 200 is used to create an alternate codeplug without modifying the existing codeplug. This is shown by the dashed line in FIG. 6. Memory 201 contains configuration information which can be used to create, modify, or replace alternate configuration data 606, without modifying original codeplug 604. In contrast, the solid line in FIG. 6 shows the preferred embodiment in which the original codeplug is updated.

Referring back to FIG. 1, programming station 160 consists of programming computer 162 and PAN module 164. PAN module 164 may be integrated into programming computer 162. Additionally, programming computer 162 contains software (not shown) that is used to communicate over the PAN to send configuration information to the radios 112 of RDP 110.

In another alternate embodiment, and as seen back in FIG. 1, programming station 160 may be substituted by radio 190, which is a PAN-equipped radio already on the scene that is already properly configured. It is preferable that radio 190 is the same model or substantially similar to radio 112 in disaster pack 110; however, this is not required to practice the invention. The configuration information of radio 190 may be provided in a generic format independent of radio model or manufacturer, and the receiving radio 112 can parse this information and make the necessary configuration changes. Additionally, this embodiment provides for a means for radio 190 to export a selected portion of its configuration information. For example, already-fielded radio 190 may have four groupings of channels or talkgroups called “zones.” A single zone or a selected set of zones can be exported from radio 190 over a PAN link to radio 112, thus adding a selected zone to radio 112. Alternatively, selection can be made on a per channel basis. The original radio 190 may have non-emergency and emergency zones, and by allowing partial updates, only configuration information pertaining to emergency infrastructure or emergency channels would be transferred to the radios 112 of RDP 110. Updates to radio 112 in this embodiment may still be accomplished while radio 112 is substantially off and while sealed in disaster pack 110.

In yet another embodiment, a mobile emergency communication system 170 including a mobile repeater or trunking system 174 and PAN module 176 may facilitate programming of radios. RDP 110 having radios 112 may be taken and programmed via PAN link at the location of communication system 170.

Accordingly, there has been provided a system and method to rapidly deploy disaster radios using wireless programming over a personal area network to program and configure a set of radios in a Rapid Deployment Pack. The system of the present invention provides an improved configuration process using fewer process steps and/or less equipment. Cables may be eliminated, and simultaneous programming may be accomplished. The system provides improved versatility by allowing an operator to download configuration information and validate configuration information to one or more radios. Such operations can be performed on radios in a sealed Rapid Deployment Pack, during or after an extended storage period. Different models or radios with different connectors can also be accommodated.

While the preferred embodiments of the invention have been illustrated and described, it will be clear that the invention is not so limited. Numerous modifications, changes, variations, substitutions and equivalents will occur to those skilled in the art without departing from the spirit and scope of the present invention as defined by the appended claims.

I claim:

1. A system to rapidly deploy one or more communication devices, the system comprising:
a set of radio configuration information, the configuration information capable of changing the operational configuration of a communication device; and
a rapid deployment pack containing at least one communication device; and
the at least one communication device containing a personal area network module; and
a programmer containing a personal area network module, the programmer capable of communication with the at least one communication device over the personal area network to download configuration information.

2. The system of claim 1, wherein the configuration information contains at least one of: frequency information, squelch code information, trunking system information, cellular system information, user ID information, and radio ID information.

3. The system of claim 1, wherein the personal area network module is powered while the communication device is turned off.

4. The system of claim 3, wherein the personal area network module includes non-volatile memory to store downloaded configuration information.

5. The system of claim 1, wherein the programmer simultaneously programs a plurality of communication devices in the rapid deployment pack.

6. The system of claim 1, wherein the rapid deployment pack is sealed.

7. A system to rapidly deploy one or more communication devices, the system comprising:
a rapid deployment pack containing at least one radio; and
the at least one radio operably coupled to a personal area network module; and
the personal area network module, capable of communication and file storage while the radio is substantially inactive; and
a programmer with a personal area network module, capable of wirelessly downloading an update file to the PAN module of the at least one radio; and
the update file containing configuration information to replace, modify, or extend the codeplug of said at least one radio.

8. The system of claim 7, further comprising firmware capable of replacing, modifying, or extending the codeplug of said radio using the update file.

9. The system of claim 7, wherein the rapid deployment pack is sealed.

10. The system of claim 7, wherein the update file contains at least one of: frequency information, squelch code information, trunking system information, cellular system information, user ID information, and radio ID information.

11. A method of deploying one or more communication devices for a communication system, comprising the steps of:
identifying radio configuration information associated with communications infrastructure;
creating an update file containing said configuration information;
loading the update file into a programmer;
placing the programmer within range of at least one radio, the at least one radio including a personal area network module;
sending wirelessly the update file to the personal area network module;
detecting by the radio a new update file from the personal area network module; and
updating the radio codeplug using the information contained within the update file.

12. The method of claim 11, further including the step of:
powering on the radio by the personal area network module if a wireless update file is received.

13. The method of claim 11, wherein the step of sending further includes the step of:
storing the update file in a memory of the personal area network module.

14. The method of claim 11, further including the steps of:
validating the update file; and
notifying the user as to the result of the updating step.

15. The method of claim 11, wherein the one or more communication devices are packaged within a single package and the step of placing the programmer within range of the at least one radio includes the step of placing the programmer in proximity to the package so as to perform the step of sending wirelessly the update file to the personal area network module.

16. The method of claim 15, wherein the at least one radio in the package is turned off prior to the step of detecting.
